(19) United States
(12) Patent Application Publication
(10) Pub. No.: US 2020/0013179 A1
(43) Pub. Date: Jan. 9, 2020

(54) INSPECTION SUPPORT APPARATUS AND INSPECTION SUPPORT METHOD

(71) Applicants: Olympus Corporation, Tokyo (JP); Kajima Corporation, Tokyo (JP)

(72) Inventors: Kenji INOSE, Tokyo (JP); Naoyuki AKIYAMA, Tokyo (JP); Naoki MORIMOTO, Tokyo (JP); Hirohisa HAYAKAWA, Sagamihara (JP); Yohei TAIRA, Tokyo (JP); Toshikazu TANIGUCHI, Tokyo (JP)

(21) Appl. No.: 16/574,020

(22) Filed: Sep. 17, 2019

Related U.S. Application Data
(63) Continuation of application No. PCT/JP2018/009622, filed on Mar. 13, 2018.

(30) Foreign Application Priority Data
Mar. 31, 2017 (JP) 2017-069434

(51) Int. Cl. G06T 7/593; G06T 7/194

(52) U.S. Cl. CPC G06T 7/593; G06T 7/194

(57) ABSTRACT

An inspection support apparatus according to an aspect includes a memory and a processor connected to the memory, and the processor is configured to obtain three-dimensional data of the structure that includes a plurality of planes formed by the frame; from the three-dimensional data, detect a plurality of first planes that include at least three points of the three-dimensional data; for each of the detected first planes, compute, from the three-dimensional data, a number of three-dimensional points at a distance that is equal to or shorter than a prescribed distance from the first plane; and according to the computed number of three-dimensional points, identify, from the detected plurality of first planes, a second plane positioned on a forefront of the frame of the structure.

### CROSS REFERENCE TO RELATED APPLICATIONS

This application is based upon and claims the benefit of priority from prior Japanese Patent Application No. 2017-069434, filed Mar. 31, 2017, the entire contents of which are incorporated herein by this reference.

This application is a continuation application of International Application PCT/JP2018/009622 filed on Mar. 13, 2018, the entire contents of which are incorporated herein by reference.

### FIELD

The embodiments disclosed herein relate to an inspection support apparatus that supports an inspection related to the frame of building and civil-engineering structures.

### BACKGROUND

In the construction of buildings of reinforced concrete, a bar arrangement inspection is performed for checking whether rebars are arranged correctly according to the bar arrangement drawing or the like. For this bar arrangement inspection, a system that supports the bar arrangement inspection (hereinafter, referred to as a “bar arrangement inspection system”) has been developed from the viewpoint of greater efficiency of the inspection, reduction of burden on the inspector, and so on. As the bar arrangement inspection system, techniques for performing the bar arrangement inspection by analyzing rebar image data captured by a digital camera have been actively developed.

### SUMMARY

An inspection support apparatus that supports an inspection related to a frame of building and civil-engineering structures according to an aspect includes a memory and a processor connected to the memory, and the processor is configured to obtain three-dimensional data of the structure that includes a plurality of planes formed by the frame; from the three-dimensional data, detect a plurality of first planes that include at least three points of the three-dimensional data; for each of the detected first planes, compute, from the three-dimensional data, a number of three-dimensional points at a distance that is equal to or shorter than a prescribed distance from the first plane; and according to the computed number of three-dimensional points, identify, from the detected plurality of first planes, a second plane positioned on a forefront of the frame of the structure.

### BRIEF DESCRIPTION OF DRAWINGS

FIG. 1 illustrates an example of the configuration of a bar arrangement inspection system.

FIG. 2 is a flow explaining the main process in the entire bar arrangement inspection system.

FIG. 3 is a block diagram illustrating an example of the hardware configuration of an information processing apparatus.

FIG. 4 is a functional block diagram related to a bar arrangement inspection process.

FIG. 5 is a flowchart explaining the procedures of a front plane parameter detection process.

FIG. 6 illustrates the relationship between a plane L)_tmp and corresponding close points.

FIG. 7 illustrates the relationship between a plane L_tmp and corresponding close points.

FIG. 8 is an example of a plane area image created by a plane area image creating unit.

FIG. 9 is a comparison of plane area images according to a front plane bar arrangement and a rear plane bar arrangement.

FIG. 10 is a functional block diagram related to an inspection support process in the second embodiment.

FIG. 11 is a flowchart explaining the procedures of a front plane parameter detection process in the second embodiment.

### DESCRIPTION OF EMBODIMENTS

For example, Japanese Laid-Open Patent Publication No. 2015-001146 mentioned above proposes a rebar inspection apparatus that measures, according to a captured image of the rebars, the distance between adjacent joints of rebars and derives the diameter of the corresponding rebars according to the measured distance between the joints.

Usually, bar arrangement is executed with division into a plurality of layers (planes), such as the front plane, the rear plane, the side planes, and the like. While the bar arrangement inspection is often conducted with the front plane layer being the target, it is difficult to capture the image of only the bar arrangement of the front plane layer on site, and rebars of the respective layers are often mixed in the captured image. For this reason, when conducting a bar arrangement inspection according to a captured image, it is necessary to extract rebars that belong to the layer being the inspection target. For example, in Japanese Laid-Open Patent Publication No. 2015-001146 mentioned above, three-dimensional points that belong to the front plane area are manually specified at the start to detect the front plane area of the bar arrangement. However, the method in which the bar arrangement area that is to be the inspection target is manually specified interferes with the automation of the inspection and also easily causes errors.

Therefore, it has been desired to provide an inspection support apparatus that accurately detects the bar arrangement area being the inspection target.

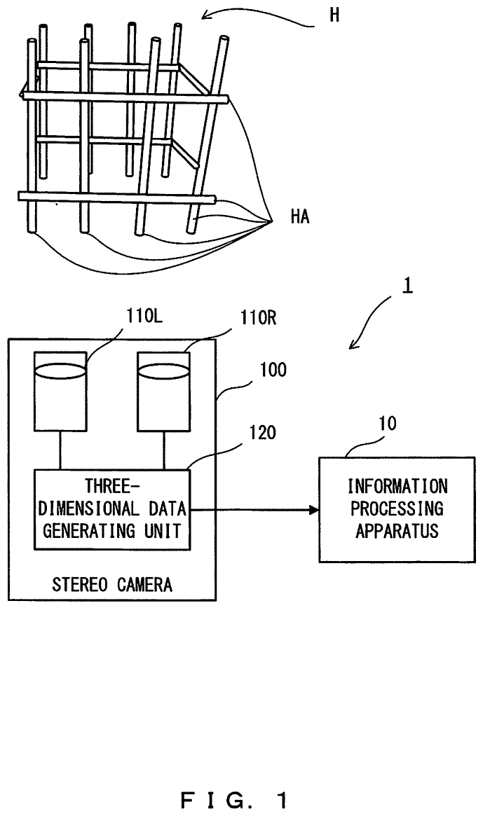

Hereinafter, embodiments of the present invention are explained according to the drawings. FIG. 1 illustrates an example of the configuration of a bar arrangement inspection system 1 according to an embodiment of the present invention. The bar arrangement inspection system 1 conducts an inspection regarding the frame of building and civil-engineering structures. Hereinafter, an example in which an image of the arranged rebars is captured and measurement processes for the rebars are performed according to the captured image is explained as a specific example of the bar arrangement inspection system 1. The measurement processes include measurement of the diameters of rebars, measurement of the number of rebars, measurement of intervals between rebars, and the like.

the bar arrangement inspection system 1 includes an information processing apparatus 10 and a stereo camera 100. The stereo camera 100 is an example of a three-dimensional data generating apparatus (also referred to as a three-dimensional sensor). The three-dimensional data generating apparatus may also be a 3D laser scanner.

A pair of images of the bar arrangement H is captured by the stereo camera 100, and the three-dimensional data of the bar arrangement H is generated. The stereo camera 100 includes a right image capturing unit 110R, a left image capturing unit 110L, and a three-dimensional data generating unit 120. The right image capturing unit 110R captures a right-eye viewpoint image viewed from the right eye. The left image capturing unit 110L captures a left-eye viewpoint image viewed from the left eye. Meanwhile, the image captured by the right image capturing unit 110R and the left image capturing unit 110L may be a color image or may be a multi-level monochrome image such as a grayscale image. In the present embodiment, it is a grayscale image.

The three-dimensional data generating unit 120 generates three-dimensional data by applying a known stereo matching process to the image data of the right-eye viewpoint image and the image data of the left-eye viewpoint image. Meanwhile, the three-dimensional data is obtained as an image that holds three-dimensional point information in units of pixels. The three-dimensional data is also called a three-dimensional image or a distance image.

The information processing apparatus 10 is a PC (Personal Computer), a tablet device, or a dedicated hardware or the like, for example. The generated three-dimensional data is obtained by the information processing apparatus 10, and the measurement target is identified by a front plane parameter computing process or the like according to the obtained three-dimensional data. Then, various measurement processes for the rebars identified as the measurement target are performed by the information processing apparatus 10. In addition, processes may also be performed by the information processing apparatus 10 to display or store the results of the processes, and so on. Hereinafter, the front plane bar arrangement HA positioned on the forefront of the bar arrangement H is assumed as the measurement target. The front plane bar arrangement HA is the bar arrangement facing the side that is closest to the stereo camera 100.

Meanwhile, the means for the information processing apparatus 10 to obtain the three-dimensional data from the stereo camera 100 may be any of wired (for example, a USB cable or the Internet), wireless (for example, a wireless Local Area Network or the Internet), or an external recording medium.

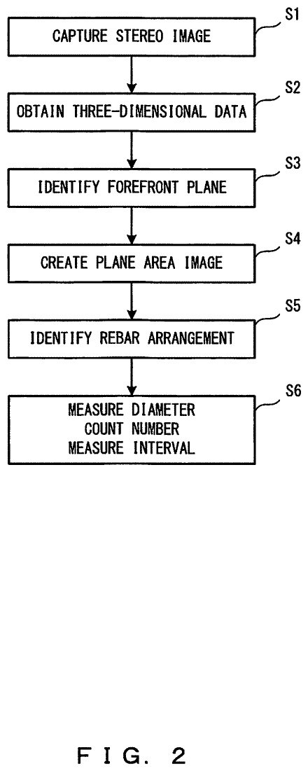

Next, the overall process in the bar arrangement inspection system 1 is briefly explained. FIG. 2 is a flow explaining the main process in the entire bar arrangement inspection system 1.

By the person who captures the image, the stereo image capturing of the bar arrangement H is performed, using the stereo camera 100 mentioned above (Step S1). The right-eye viewpoint image and the left-eye viewpoint image are captured by the stereo camera 100, and the three-dimensional data is generated. The information processing apparatus 10 obtains the three-dimensional data from the stereo camera 100 (Step S2). The information processing apparatus 10 identifies the plane on the forefront from the three-dimensional data (Step S3). The plane on the forefront refers to the place positioned on the forefront with respect to the stereo camera 100 in the planes formed by the frame of building and civil-engineering structures. Specifically, the plane on the forefront is the plane in FIG. 1 that includes the front plane bar arrangement HA.

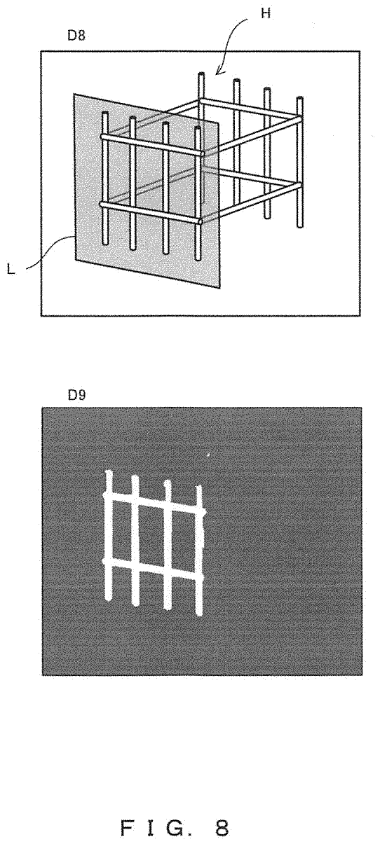

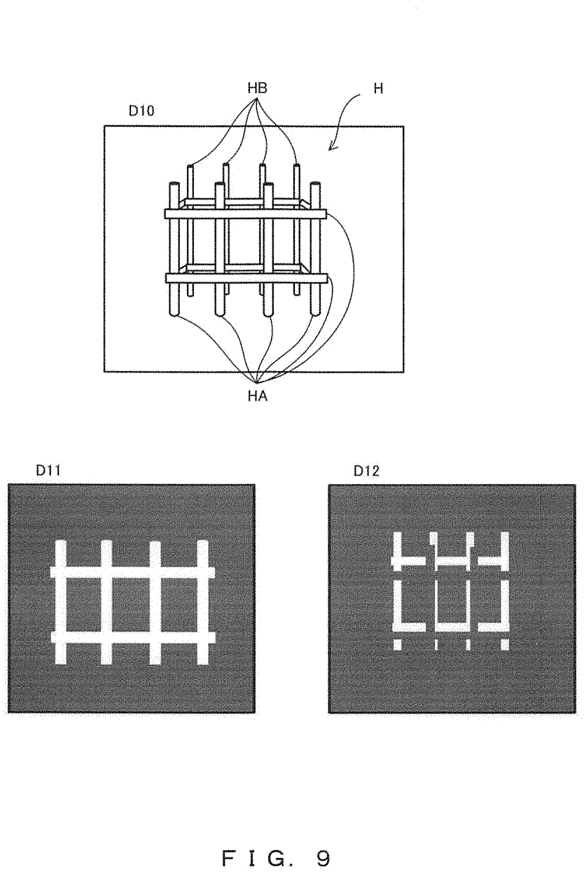

The information processing apparatus 10 creates a plane area image according to the identified plane on the forefront (Step S4) and identifies the arrangement of rebars that is to be the measurement target (Step S5). The plane area image is explained in FIG. 8 and FIG. 9. The information processing apparatus 10 performs various measurement processes such as measurement of the diameters, measurement of the number, measurement of intervals, and the like, for the rebars being the target, according to the identified arrangement of rebars. (Step S6).

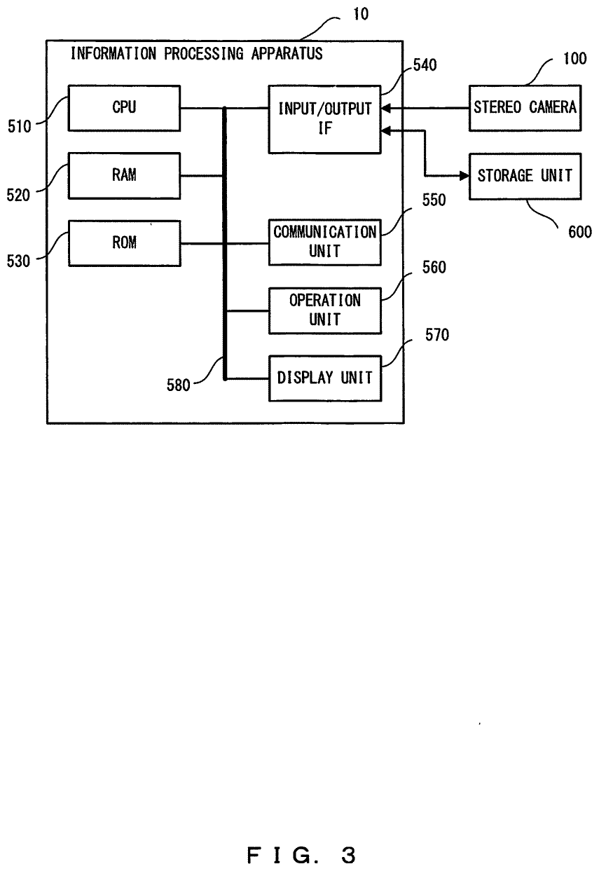

FIG. 3 is a block diagram illustrating an example of the hardware configuration of an information processing apparatus 10. The information processing apparatus 10 includes a CPU (Central Processing Unit) 510, a RAM (Random Access Memory) 520, a ROM (Read Only memory) 530, an input/output IF (Interface) 540, a communication unit 550, an operation unit 560, a display unit 570, and a bus 580.

The CPU 510 is a control unit that integrally controls the entire information processing apparatus 10. Meanwhile, the CPU 510 is an example of a processor, and the processes performed by the CPU 510 may also be performed by the processor. The CPU 510 loads a control program from the ROM 530 and performs various control processes according to the loaded control program.

The RAM 520 is a work area that temporality stores various data such as the control program, three-dimensional data from the stereo camera 100, and the like. The RAM 520 is a memory such as a DRAM (Dynamic Random Access Memory) or the like, for example. The ROM 530 is a non-volatile storage unit that stores the control program, data, and the like. The ROM 530 is a memory such as a flash memory or the like, for example.

The input/output IF 540 performs transmission and reception of data with an external device. The external device is the stereo camera 100 connected by a USB cable or the like, or an exchangeable storage unit 600, for example. The information processing apparatus 10 obtains the three-dimensional data by the input/output IF 540 from the stereo camera 100. The input/output IF 540 is also referred to as a three-dimensional data obtaining unit. The storage unit 600 is a recording medium that is so called a memory card. The storage unit 600 may also be an HDD (Hard Disk Drive). The three-dimensional data generated by the stereo camera 100, the plane area image generated by the information processing apparatus 10 according to the three-dimensional data, and the like may be stored in the storage unit 600.

The communication unit 550 performs communication of various data wirelessly with an external device. The operation unit 560 is a keyboard, a touch panel, or the like that inputs operation instructions. The display unit 570 is an LCD (liquid crystal display) for example and displays input data or a captured image, an image according to the three-dimensional data, and the like. The CPU 510 is connected to the RAM 520, the ROM 530 and so on by the bus 580.

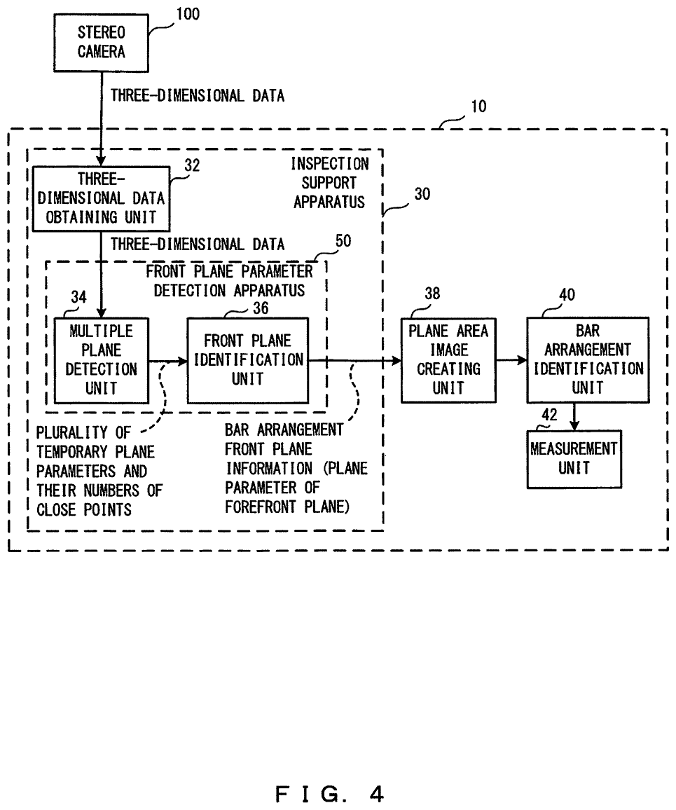

FIG. 4 is a functional block diagram related to a bar arrangement inspection process by the information processing apparatus 10 in the bar arrangement inspection system 1. The bar arrangement inspection process is performed by software processing by the loading of the control program by the CPU 510 and the execution of the loaded control program by the CPU 510.

As illustrated in FIG. 4, the bar arrangement inspection process is realized by a three-dimensional information obtaining unit 32, a multiple plane detection unit 34, a front plane identification unit 36, the plane area image creating unit 38, a bar arrangement identification unit 40 and a measurement unit 42, and the like. The respective units, namely the three-dimensional information obtaining unit 32 through the measurement unit 42 mentioned above are functions realized by software processing. In addition, the three-dimensional information obtaining unit 32, the multiple plane detection unit 34 and the front plane identification unit 36 identify the plane on the forefront to support the bar arrangement inspection as described later, and therefore, they are also collectively referred to as an inspection support apparatus 30.

The three-dimensional information obtaining unit 32 obtains the three-dimensional data from the stereo camera 100. The three-dimensional information obtaining unit 32 is the input/output IF 540 for example, as mentioned above.

The multiple plane detection unit 34 detects a plurality of planes that include at least three points of the three-dimensional data, from the obtained three-dimensional data. Specifically, for example, the multiple plane detection unit 34 selects three points from the obtained three-dimensional data, sets a temporary plane (also referred to as a first plane) formed by the three points, and detects a plurality of such temporary planes.

Then, the multiple plane detection unit 34 extracts, for each of the detected temporary planes, three-dimensional points that are at a distance to the temporary plane that is equal to or smaller than a prescribed distance, as three-dimensional points belonging to the temporary plane. The three-dimensional points are the respective points of the three-dimensional data. The multiple plane detection unit 34 calculates the number of three-dimensional points belonging to each of the temporary planes. The multiple plane detection unit 34 outputs the parameters (referred to as a plane parameter) of the detected temporary planes and the number of three-dimensional points belonging to each of the temporary planes.

The front plane identification unit 36 identifies the plane on the forefront from the plurality of temporary planes output from the multiple plane detection unit 34. Specifically, the front plane identification unit 36 identifies the plane positioned on the forefront of the frame of the structure (the plane on the forefront), from the detected plurality of temporary planes, according to the number of three-dimensional points belonging to each of the temporary planes. The plane on the forefront is also referred to as the second plane. More specifically, the front plane identification unit 36 identifies, as the plane on the forefront, the temporary plane that has the largest number of calculated three-dimensional points in the detected plurality of temporary planes. The front plane identification unit 36 outputs the plane parameter of the identified plane on the forefront to the plane area image creating unit 38 as bar arrangement front plane information.

Meanwhile, the parameters of the plane on the forefront are also referred to as front plane parameters, and the multiple plane detection unit 34 and the front plane identification unit 36 are also referred to as a front plane parameter detection apparatus 50 together. The processing by the front plane parameter detection apparatus 50 is also referred to as a front plane parameter detection.

The plane area image creating unit 38 creates an image of the front plane bar arrangement HA from the obtained three-dimensional data, according to the parameters of the plane on the forefront. The bar arrangement identification unit 40 identifies the arrangement of rebars, from the image of the front plane bar arrangement HA. The measurement unit performs various measurement processes such as measurement of the diameters of rebars, measurement of the number of rebars, measurement of intervals between rebars, and the like, according to the identified arrangement of rebars.

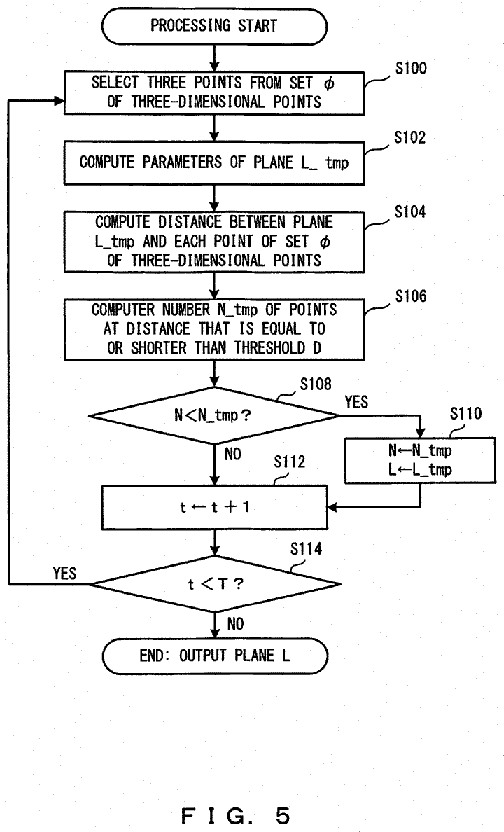

FIG. 5 is a flowchart explaining the procedures of the front plane parameter detection process. The front plane parameter detection process is performed by the front plane parameter detection apparatus 50 (the multiple plane detection unit 34 and the front plane identification unit 36).

First, the multiple plane detection unit 34 and the front plane identification unit 36 perform initialization of variables (t, N) for loop processing. The multiple plane detection unit 34 selects at least three points from the set ϕ of the three-dimensional points (Step S100). The multiple plane detection unit 34 computes the parameters of the plurality of planes L_tmp (Step S102) according to the selected points. The plane L_tmp is the temporary plane mentioned above.

Meanwhile, the parameters of the plane L_tmp are coefficients a, b, c, d of a plane equation expressed as the expression (1) below.

ax+by+cz+d=0 Expression (1)

Here, (x, y, z) represent coordinates of points in a three-dimensional space. The parameters of the plane L_tmp may be computed using known techniques such as the least-squares method. Meanwhile, when the selected points are three points, one plane may be computed by the calculation. Meanwhile, the points to be selected are not limited to three points and may be three points or more.

The multiple plane detection unit 34 computes the distance between the plane L_tmp and each point of the set ϕ of three-dimensional points (Step S104). The multiple plane detection unit 34 computes the number N_tmp of points at a distance to the plane L_tmp that is equal to or smaller than a threshold D, in the set ϕ of three-dimensional points (Step S106). That is, the multiple plane detection unit 34 calculates the number of three-dimensional points near the plane L_tmp. The threshold D is a value set in advance, and it may be stored in the ROM 530. The threshold D may be the radius or the diameter of the rebar to be the target. Three-dimensional points at a distance to the plane L_tmp equal to or smaller than the threshold D are referred to as close points. From the set ϕ of three-dimensional points, the number N_tmp of close points that satisfies the expression (2) as the relationship between the distance to the plane L_tmp and the threshold D is calculated.

|ax+by+cz+d|<D Expression (2)

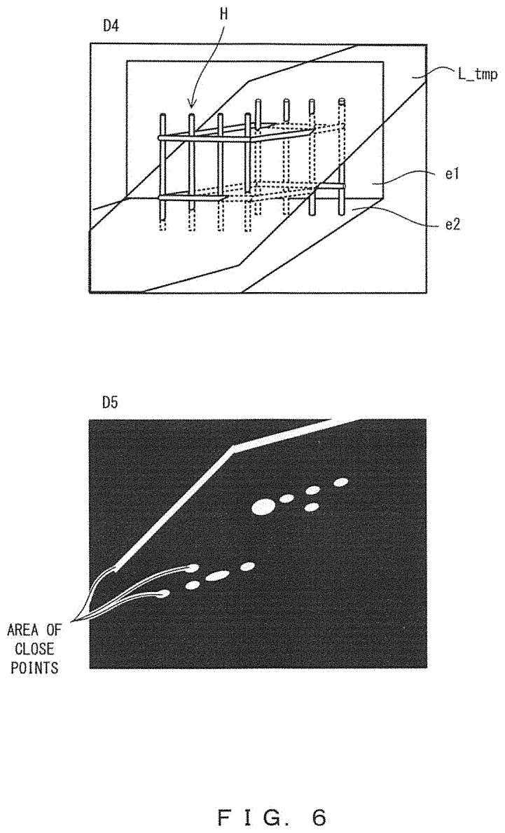

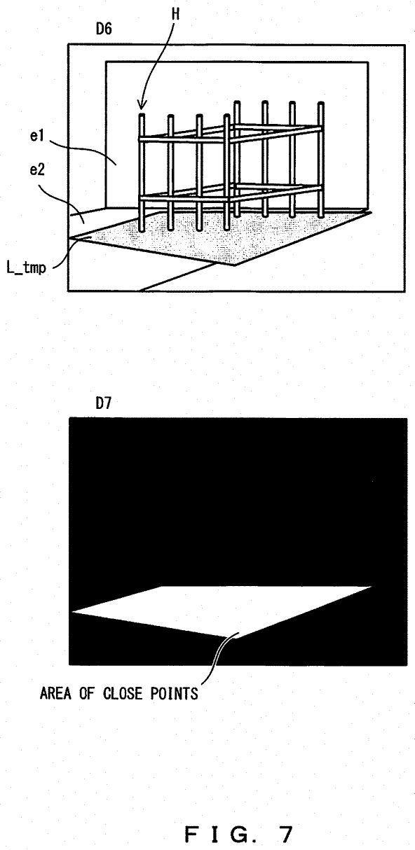

Referring to FIG. 6, FIG. 7 and FIG. 8, Step S100 through Step S106 are explained with a specific example. FIG. 6 and FIG. 7 illustrate the relationship between the plane L_tmp and the number N_tmp of close points corresponding to the plane L_tmp.

A plurality of planes L_tmp are detected from the set ϕ of three-dimensional points. The image D4 in FIG. 6 and the image D6 in FIG. 7 are an example of such. In the example of the drawings, the bar arrangement H, a wall plane e1, and a floor plane e2 are included in the scene. The plane L_tmp presented in the image D4 in FIG. 6 is an inclined plane that obliquely crosses the bar arrangement H from the front lower area of the bar arrangement H to the rear upper area of the bar arrangement H. The plane L_tmp presented in the image D6 in FIG. 7 is a plane that is parallel to the floor plane e2 and also close to the floor plane e2.

The image D5 in FIG. 6 presents the areas of the close points computed on the plane L_tmp (inclined plane) in the image D4 in white. Areas such as the area in which the plane L_tmp in the image D4 intersects with the bar arrangement H and the area in which the plane L_tmp in the image D4 intersects with the wall plane e1 correspond to the areas of the close points on the plane L_tmp (inclined plane). In an actual calculation example, the number N_tmp of close points was computed as 84,032.

The image D7 in FIG. 7 presents the area of the close points computed on the plane L_tmp in the image D6 in white. Because of the plane L_tmp proximity to the floor plane e2, the area of the floor plane e2 is included in the area of the close points. In an actual calculation example, the number N_tmp of close points was computed as 310,075.

According to FIG. 7, it can be understood that it is desirable to exclude the floor plane and the wall plane. The multiple plane detection unit 34 exclude the floor plane and the wall plane according to the coordinate values of the three-dimensional data, for example. Alternatively, the multiple plane detection unit 34 may estimate and exclude planes L_tmp whose number N_tmp of close points is equal to or larger than a prescribed number as the floor plane and the wall plane.

Then, from Step S110 in FIG. 5 onward, the temporary plane having the largest number N_tmp of close points is selected from the temporary planes from which the floor plane and the wall plane are excluded, and the selected temporary plane is identified as the plane on the forefront of the bar arrangement. The reason for that is explained.

As illustrated in FIG. 6, when the temporary plane is in a direction that intersects with the rebars, the number N_tmp of close points becomes small. Meanwhile, when the temporary plane is in a direction that is parallel to an axis direction of the rebars, the number N_tmp of close points becomes large. That is, it is because temporary planes that are parallel to a plane of the bar arrangement have larger numbers N_tmp of close points. Furthermore, an image is captured in which rebars on the front plane, which is at the closer distance to the stereo camera 100, appear to be larger in size (the thicknesses of rebars and the lengths of rebars) than those on the rear plane (see FIG. 9). That is, the number N_tmp of close points becomes larger for the rebars on the front plane than for the rebars on the rear plane. According to the above, it follows that the temporary plane having the largest number N_tmp of close points may be estimated as the plane on the forefront the bar arrangement.

Back to FIG. 5. In Step S110 through Step S114 below, the front plane identification unit 36 compares the computed numbers N_tmp of close points of planes L temp sequentially and identifies the plane L_tmp having the largest number N_tmp of close points as the plane on the forefront.

The front plane identification unit 36 determines whether N<N_tmp is true (Step S108). N is the tentative largest value of the number N_tmp of close points. When the front plane identification unit 36 determines that N<N_tmp is true (YES in Step S108), the front plane identification unit 36 updates N with N_tmp and updates the plane L with the plane L_tmp (Step S110). The plane L is the tentative parameters of the plane on the forefront.

The front plane identification unit sets t=t+1 (Step S112). t is a loop counter for comparing N_tmp of planes L_tmp sequentially.

The front plane identification unit 36 determines whether t<T is true (Step S114). T is the total number of temporary planes computed in Step S104. The process is terminated when t=T. Upon determining that t<T is true (YES in Step S114), the front plane identification unit 36 returns to Step S100 and performs the process for the next plane L_tmp.

Upon determining that N<N_tmp is not true (NO in Step S108), the front plane identification unit 36 proceeds to Step S112. After Step S112, upon determining that t<T is not true (NO in Step S114), the front plane identification unit 36 identifies the plane L as the plane parameter corresponding to the front plane of the bar arrangement and outputs it to the plane area image creating unit 38. Then, the front plane parameter detection process is terminated.

The processes from Step S100 through Step S114 described above are common with the processing process of the parameter estimation method according to the RANSAC (Random Sample Consensus) process. The RANSAC process has been developed and used with the original intention being the estimation of a numerical model from measured values that include outliers (abnormal values). In the present embodiment, a process equivalent to the RANSAC process is performed with an intention that is different from the original intention of the RANSAC process.

FIG. 8 is an example of the plane area image created by the plane area image creating unit 38. The image D8 presents the three-dimensional image of the bar arrangement H and the plane L set to include the front plane bar arrangement of the bar arrangement H. The image D9 is the plane area image corresponding to the plane L of the image D8.

FIG. 9 is a comparison of the plane area image (image D11) according to the front plane bar arrangement HA of the bar arrangement H and the plane area image (image D12) according to the rear plane bar arrangement HB. The image D10 is a three-dimensional image that is the base of the image D11 and the image D12. In the front plane bar arrangement HA, the distance to the stereo camera 100 is shorter than that for the rear plane bar arrangement HB, and therefore, the size of rebars is displayed to be larger than that for the rear plane bar arrangement HB. That is, the area displayed as the bar arrangement is larger in the image D11 than in the image D12. That is, the number N_tmp of close points in the image D11 is larger than the number N_tmp of close points in the image D12. According to the above, the plane having the largest number N_tmp of close points may be identified as the plane on the forefront.

The front plane parameter detection process explained above is summarized as processes below.
Select arbitrary three or more points from input three-dimensional data and compute a plane parameter according to these points.
With respect to the input three-dimensional data, compute distances to the computed plane, and count the number of points at distances that are equal to or shorter than a threshold.
Repeatedly perform computation of the plane parameter and the counting of the number of points at distances to the plane equal to or shorter than a threshold described above, while reselecting arbitrary three or more points. Accordingly, a plurality of sets of pairs of the plane parameter and the number are computed.
From the pairs of the plane parameter and the number described above, obtain the plane parameter of the pair having the largest of the number as the plane corresponding to the front plane of the bar arrangement.

Then, according to the front plane parameter detection process explained above, the bar arrangement on the forefront is automatically detected using that, in obtained three-dimensional data, the largest volume of three-dimensional point data corresponds to the front plane. Accordingly, the bar arrangement on the forefront is detected certainly by the front plane parameter detection process according to the present embodiment.

### Second Embodiment

Next, the second embodiment is explained. In the front plane parameter detection process described above, the multiple plane detection unit 34 excludes the floor plane and the wall plane in advance from the temporary plane. In the second embodiment, further, three-dimensional data that are away from the three-dimensional data generating apparatus (the stereo camera 100) by a distance equal to or larger than a prescribed distance is excluded from the set ϕ of three-dimensional points used by the multiple plane detection unit 34. This is because the measurement target is the bar arrangement on the forefront, and therefore, three-dimensional points at the side that are away from the stereo camera 100 by an amount equal to or more than a prescribed amount are not needed.

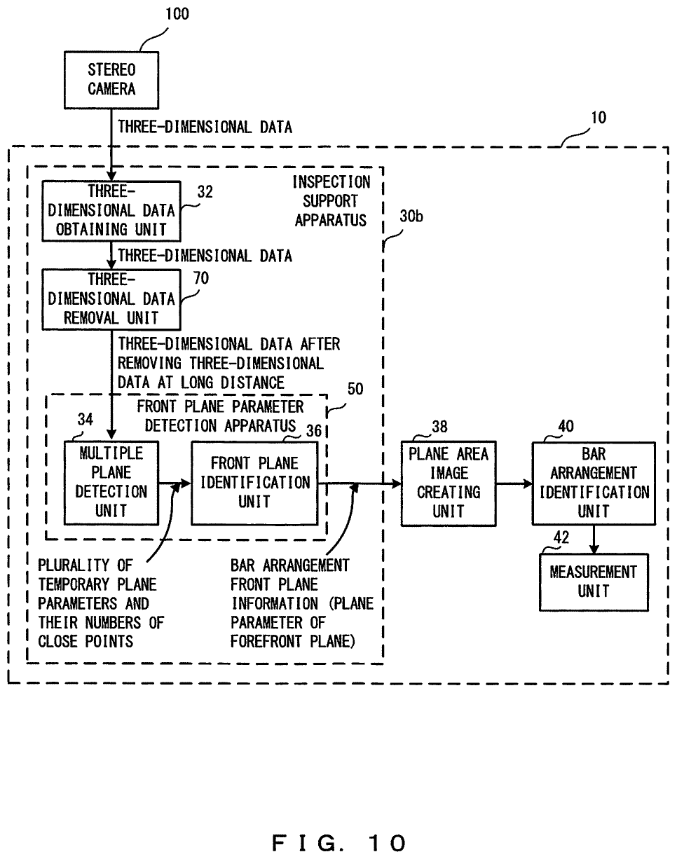

The second embodiment has many common portions with the first embodiment explained with drawings up to FIG. 9. Hereinafter, the points particular to the second embodiment are mainly explained. FIG. 10 is a functional block diagram related to the bar arrangement inspection process in the second embodiment.

In an inspection support apparatus 30b in the second embodiment, a three-dimensional data removal unit 70 is added to the inspection support apparatus 30 of the first embodiment. The three-dimensional data removal unit 70 identifies three-dimensional data that are away from the three-dimensional data generating apparatus (the stereo camera 100) by a distance equal to or larger than a prescribed distance and excludes the identified three-dimensional data from the set ϕ of three-dimensional points. Then, the three-dimensional data removal unit 70 outputs, to the multiple plane detection unit 34, the set ϕ of three-dimensional points from which the identified three-dimensional data are excluded. The prescribed distance is 3 m in the case in which the distance to the front plane bar arrangement HA is 2 m, for example.

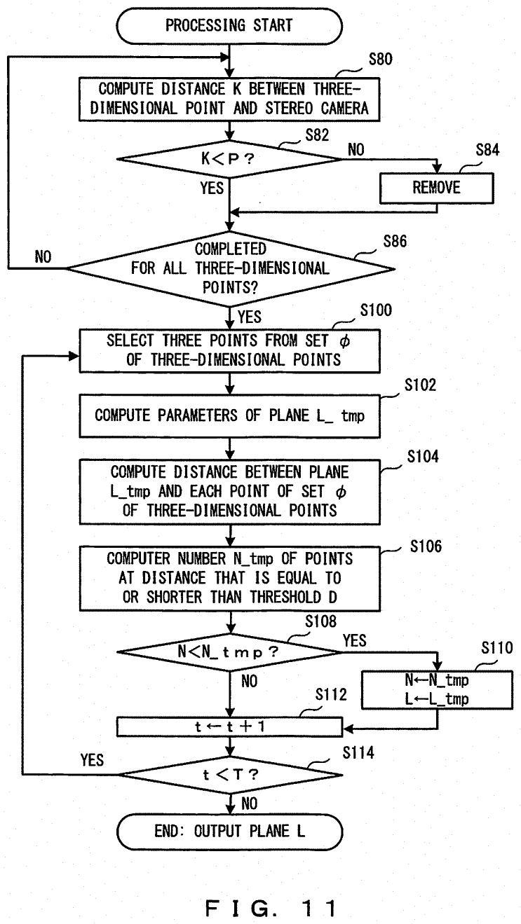

FIG. 11 is a flowchart explaining the procedures of the front plane parameter detection process in the second embodiment. Step S80 through Step S86 are the processes particular to the second embodiment. Step S100 through Step S114 are the same processes as in the first embodiment.

The three-dimensional data removal unit 70 reads three-dimensional points one by one from the set ϕ of three-dimensional points and performs the processes of Step S80 through Step S86 below.

The three-dimensional data removal unit 70 computes, from the coordinates of a three-dimensional point (x, y, z), a distance K between the three-dimensional point and the stereo camera 100 (Step S80). The three-dimensional data removal unit 70 determines whether K<P is true (Step S82). P is a value in which a certain margin value is added to the distance to the front plane bar arrangement HA positioned on the forefront. As the distance to the front plane bar arrangement HA, a distance value measured by the stereo camera 100 may be used, or it may also be an input value from the person who captures the image.

Upon determining that K<P is not true (NO in Step S82), the three-dimensional data removal unit 70 removes the three-dimensional point (Step S84) and proceeds to Step S86. This is because the three-dimensional point can be determined as a point that is not included in the front plane bar arrangement HA.

Upon determining that K<P is true (YES in Step S82), the three-dimensional data removal unit 70 determines whether the process has been completed for all of the three-dimensional points (Step S86). Upon determining that the process has not been completed for all of the three-dimensional points (NO in Step 86), the three-dimensional data removal unit 70 returns to Step S80. Upon determining that the process has been completed for all of the three-dimensional points (YES in Step S86), the three-dimensional data removal unit 70 proceeds to Step S100. Explanation for Step S100 and subsequent steps is omitted as they have already been explained.

According to the second embodiment, the three-dimensional data based on the bar arrangement on the far side and the wall plane, and the like may be efficiently removed by the three-dimensional data removal unit 70. By excluding unnecessary three-dimensional points in advance, the volume of three-dimensional data is reduced, and the time taken for the front plane parameter detection process is shortened. Meanwhile, the removal process described above may also be performed in the multiple plane detection unit (in the RANSAC process).

### VARIATION EXAMPLE

In FIG. 1, the information processing apparatus 10 and the stereo camera 100 (the three-dimensional data generation apparatus) are explained as separate bodies, but they may also be an integrated apparatus (a tablet device built in the stereo camera). In addition, the inspection support apparatus 30 (30b) is explained to be realized by software processing, but this is not a limitation. A part of or the entirety of the inspection support apparatus 30 (30b) may be executed by hardware processing (for example, a gate array circuit).

According to the embodiments described above, an inspection support apparatus that properly detects the area of the bar arrangement to be the inspection target may be provided.

Meanwhile, the present invention is not limited to the exact embodiments described above, and at the stage of implementation, embodiments may be made while applying variation to the components without departing from its scope. In addition, various inventions may be formed by appropriately combining a plurality of components disclosed in the embodiments described above. For example, the entire components disclosed in an embodiment may be appropriately combined. Furthermore, components across different embodiments may be appropriately combined. It goes without saying that various variations and applications may be made without departing from the gist of the invention.

What is claimed is:

1. An inspection support apparatus that supports an inspection related to a frame of building and civil-engineering structures, comprising:
a memory; and
a processor connected to the memory, wherein
the processor is configured to
obtain three-dimensional data of the structure that includes a plurality of planes formed by the frame;
from the three-dimensional data, detect a plurality of first planes that include at least three points of the three-dimensional data;
for each of the detected first planes, compute, from the three-dimensional data, a number of three-dimensional points at a distance that is equal to or shorter than a prescribed distance from the first plane; and
according to the computed number of three-dimensional points, identify, from the detected plurality of first planes, a second plane positioned on a forefront of the frame of the structure.

2. The inspection support apparatus according to claim 1, wherein
the processor identifies, as the second plane, a first plane having the largest computed number of three-dimensional points in the detected plurality of first planes.

3. The inspection support apparatus according to claim 1, wherein
the three-dimensional data include data that are irrelevant to the second plane, and
the processor identifies the second plane from the three-dimensional data by RANSAC algorithm.

4. The inspection support apparatus according to claim 1, wherein
the three-dimensional data are created from data obtained by a three-dimensional sensor, and
the processor performs detection of the first plane while excluding, from the three-dimensional data, a three-dimensional point that is away from the three-dimensional sensor by a distance equal to or larger than a prescribed distance.

5. The inspection support apparatus according to claim 1, wherein
the processor excludes, from the three-dimensional data, a three-dimensional point that is away from a sensor for generating the three-dimensional data by a distance equal to or larger than a prescribed distance, and
according to the remaining three-dimensional data after exclusion, the processor detects a plurality of first planes that include at least three points of the three-dimensional data.

6. An inspection support method for supporting an inspection related to a frame of building and civil-engineering structures, comprising:
obtaining three-dimensional data of the structure that includes a plurality of planes formed by the frame;
from the three-dimensional data, detecting a plurality of first planes that include at least three points of the three-dimensional data;
for each of the detected first planes, computing, from the three-dimensional data, a number of three-dimensional points at a distance that is equal to or shorter than a prescribed distance from the first plane; and
according to the computed number of three-dimensional points, identifying, from the detected plurality of first planes, a second plane positioned on a forefront of the frame of the structure.

7. A non-transitory computer-readable medium storing a program causing a computer execute an inspection support process that supports an inspection related to a frame of building and civil-engineering structures, the inspection support process comprising:
obtaining three-dimensional data of the structure that includes a plurality of planes formed by the frames;
from the three-dimensional data, detecting a plurality of first planes that include at least three points of the three-dimensional data;
for each of the detected first planes, computing, from the three-dimensional data, a number of three-dimensional points at a distance equal to or shorter than a prescribed distance from the first plane; and
according to the computed number of three-dimensional points, identifying, from the detected plurality of first planes, a second plane positioned on a forefront of the frame of the structure.
